(19) United States
(12) Patent Application Publication
(10) Pub. No.: US 2009/0256737 A1
(43) Pub. Date: Oct. 15, 2009

(54) RADAR LEVEL GAUGE SYSTEM WITH MULTI BAND PATCH ANTENNA ARRAY ARRANGEMENT

(75) Inventor: Magnus Ohlsson, Norsholm (SE)

Correspondence Address: WESTMAN CHAMPLIN & KELLY, P.A., SUITE 1400, 900 SECOND AVENUE SOUTH, MINNEAPOLIS, MN, 55402, US

(73) Assignee: Rosemount Tank Radar AB, Goteborg (SE)

(21) Appl. No.: 12/101,297

(22) Filed: Apr. 11, 2008

(51) Int. Cl. H01Q 9/04; G01S 13/08

(52) U.S. Cl. 342/124; 343/700 MS

(57) ABSTRACT

A radar level gauge system (1) having an antenna arrangement (3) adapted to emit microwaves towards a surface (7) of the product (6) and to receive microwaves reflected from the surface (7) The antenna arrangement (3) includes a reflector (8) and a multi band patch antenna array (9) arranged at a distance from the reflector (8) and adapted to emit electromagnetic waves to be reflected by the reflector towards the surface (6). The array (9) has first and second groups of radiator elements (19) adapted to emit electromagnetic radiation with first and second radiation footprints (14, 15), wherein the second radiation footprint (15) is substantially equal to the first radiation footprint (14), and wherein the reflector (8) has a size corresponding to the first and second radiation footprints (14, 15).

According to the present invention, the reflector will be adapted to receive most of the radiation in the first and second radiation footprints. This results in an optimized antenna arrangement, where the amount of radiation energy emitted without reaching the reflector is reduced, while at the same time the full reflector size is used for both frequency bands.

### TECHNICAL FIELD OF THE INVENTION

The present invention relates to an antenna arrangement adapted to, on at least one first frequency band and at least one second frequency band, transmit microwaves towards a surface of a product stored in a tank and receiving microwaves reflected from the surface.

### BACKGROUND ART

Radar level gauge systems are in wide use for measuring process variables of a product contained in a tank, such as filling level, ullage or volume. Radar level gauging is generally performed by means of non-contact measurement, whereby electromagnetic signals are allowed to propagate freely towards the product contained in the tank. The electromagnetic signals are subsequently reflected at the surface of the product, and the reflected signals are received by a receiver or transceiver comprised in the radar level gauge system. Based on the transmitted and reflected signals, the distance to the surface of the product can be determined.

Radar level gauges for use within the processing industry, for example, must however be able to function under very different conditions. The product stored may be for instance petroleum, refinery products, liquid gases and other chemical compounds. This implies that such parameters as temperature and pressure can be of very shifting values. Disturbing structures also exist inside the tank, for instance devices as agitators etc. Additionally, many liquids or tank conditions create a foam layer on the liquid or a layer of dirt on the antenna, whereby measuring is rendered more difficult and may go wrong.

In order to compensate for the various factors complicating the measuring process, use of two different microwave frequency bands has been suggested in the art. With the introduction of widely separated frequencies, preferably one high-penetration frequency band and one band representing a narrow beam, differences in attenuation due to foam on the surface and the differences in beam-width, or other disturbances, may be utilized to obtain more accurate measurements. The provision of multiple frequencies is achieved by use of plural radar level gauges, where each gauge operates at a different frequency band, or by use of a single gauge supporting multiple frequency bands. With regards to the latter, U.S. Pat. No. 7,053,630, for instance, discloses a radar level gauge for measuring the level of a surface of a product stored in a tank by use of radar, emitting radar waves within two widely separated frequency bands. One way to provide a dual band antenna is to arrange a dual band patch antenna to illuminate a reflector. However, there is a need for a solution taking into consideration optimized use of the reflector.

### General Disclosure of the Invention

It is therefore an object of the present invention to provide an antenna assembly of the type mentioned by way of introduction, in which the above-related drawbacks are eliminated wholly or at least partly.

According to a first aspect of the invention, this and other objects are achieved by a radar level gauge system for determining a process variable of a product contained in a tank, the system comprising transceiver circuitry for generating, transmitting and receiving microwave signals on at least a first and a second frequency band, a ratio between center frequencies of said first and second frequency bands being at least 1.5 and preferably at least 2, an antenna arrangement connected to the transceiver and adapted to emit microwaves towards a surface of the product and to receive microwaves reflected from the surface, and a measurement electronics unit connected to the transceiver, for determining the process variable based on a relationship between emitted and received microwaves. The antenna arrangement includes a reflector and a multi band patch antenna array arranged at a distance from the reflector and adapted to emit electromagnetic waves to be reflected by the reflector towards the surface. The array has a first group of radiator elements adapted to emit electromagnetic radiation in the first frequency band, the radiation having a first radiation footprint defined as a projection of radiation in the first frequency band that, at the distance, has sufficient power per area unit to be received by the radiator elements after reflection by the reflector and the surface, and a second group of radiator elements adapted to emit electromagnetic radiation in the second frequency band, the radiation having a second radiation footprint defined as a projection of radiation in the second frequency band that, at the distance, has sufficient power per area unit to be received by the radiator elements after reflection by the reflector and the surface. Further, the second radiation footprint is substantially equal to the first radiation footprint, and the reflector has a size corresponding to the first and second radiation footprints.

The radiation footprint may be defined as the area within which the radiated power from the antenna array per area unit is above a given level, e.g. expressed in terms of the maximum radiation power. As an example, the radiation footprint can be the area within which the radiation level is 10 dB below the maximum radiation level.

The reflector is preferably arranged at a distance from the array where the angular distribution of the radiation no longer practically changes with distance, commonly known as the “far field”.

The term “substantially equal” is, in the context of this application, to be understood in a broad sense, for example meaning that the second radiation footprint differs less than 20 percent, more preferably less than 10 percent, and most preferably less than 5 percent in comparison to the first radiation footprint.

According to the present invention, the reflector will be adapted to receive most of the radiation in the first and second radiation footprints. This results in an optimized antenna arrangement, where the amount of radiation energy emitted without reaching the reflector is reduced, while at the same time the full reflector size is used for all emitted frequency bands.

This may be particularly advantageous in case of an “offset” antenna arrangement, i.e. when the reflector is an off-center portion of an imagined “full size” parabolic antenna (i.e. an antenna having the shape of an elliptic paraboloid). By “off-center” means that the portion does not include the extreme point of the paraboloid surface. By using an embodiment of the present invention, the size of the reflector can be selected to correspond to the size and shape of the substantially equal radiation footprints.

In order to achieve substantially equal radiation footprints for the separate frequency bands, the radiator elements of the first group, i.e. the LF-elements, may be located in a first plane, and the radiator elements of the second group, i.e. the HF-elements, located in a second plane, which planes are essentially perpendicular to a radiation direction of the array. The first plane is located between the second plane and the reflector. Through this arrangement, the high frequency elements in the second plane are located closer to a ground plane arranged beneath both planes. This serves to optimize the bandwidths for the respective frequency bands.

In order to further contribute to generation of the desired equal radiation footprints of the reflector for the different frequency bands, the radiator elements may be shaped and arranged in a plurality of manners. For instance, in the case of two separated frequency bands, the radiator elements of the first and/or second groups, respectively, preferably have rectangular shapes providing the desired functionality. Furthermore, with regards to the second frequency band, a desired functionality may be obtained with the second group comprising only one element, whereby a minimum of HF-elements is required for the provision of the high frequency band. Additionally, the first group preferably, although not necessarily, comprises four elements, which may be arranged symmetrically relatively to the second group, thereby contributing to a desired interaction between the HF- and LF-elements. In order to furthermore contribute to avoiding interference between the HF- and LF-elements, an LF-element may have the corner facing an HF-element removed. Even more preferred is to have not only one, but all four corners of the LF-element removed, the LF-element thereby forming the shape of a cross, whereby additionally symmetry for the LF-element is preserved.

To furthermore optimize the gauge system, the measurement electronics unit is preferably adapted to, in dependence of a performed analysis of a received microwave signal spectrum, determine on which frequency band(s) the level gauging system shall operate. Thereby, differences in attenuation due to foam on the surface and the differences in beam-width, or other disturbances, may be taken into consideration, such that more accurate measurements may be obtained.

Other aspects, benefits and advantageous features of the invention will be apparent from the following description and claims.

### BRIEF DESCRIPTION OF THE DRAWINGS

These and other aspects of the present invention will now be described in more detail, with reference to the appended drawings showing currently preferred embodiments of the invention, wherein:

FIG. 1 schematically illustrates an exemplary radar level gauge system according to an embodiment of the present invention, installed in a tank;

FIG. 2 is a schematic illustration of the antenna arrangement and the measurement electronics unit comprised in the radar level gauge system of FIG. 1;

FIG. 3 schematically illustrates, in an exploded view, an exemplary design of the multi band patch antenna array utilized in the embodiment of FIG. 1A;

FIG. 4A schematically illustrates, from a top view, the arrangement of the radiator elements of the multi band patch antenna array in FIG. 3; and

FIGS. 4B-4F schematically illustrate, from a top view, alternative arrangements of the radiator elements according to the present invention.

### DETAILED DESCRIPTION OF THE PREFERRED EMBODIMENTS OF THE INVENTION

In the present detailed description, reference is mainly made to filling level determination by means of measuring the time between transmitted and reflected pulses. However, as is evident to the person skilled in the relevant art, the teachings of the present invention are equally applicable to radar level gauge systems utilizing phase information for determining the filling level through, for example, frequency-modulated continuous wave (FMCW) measurements. When pulses modulated on a carrier are used, phase information can also be utilized.

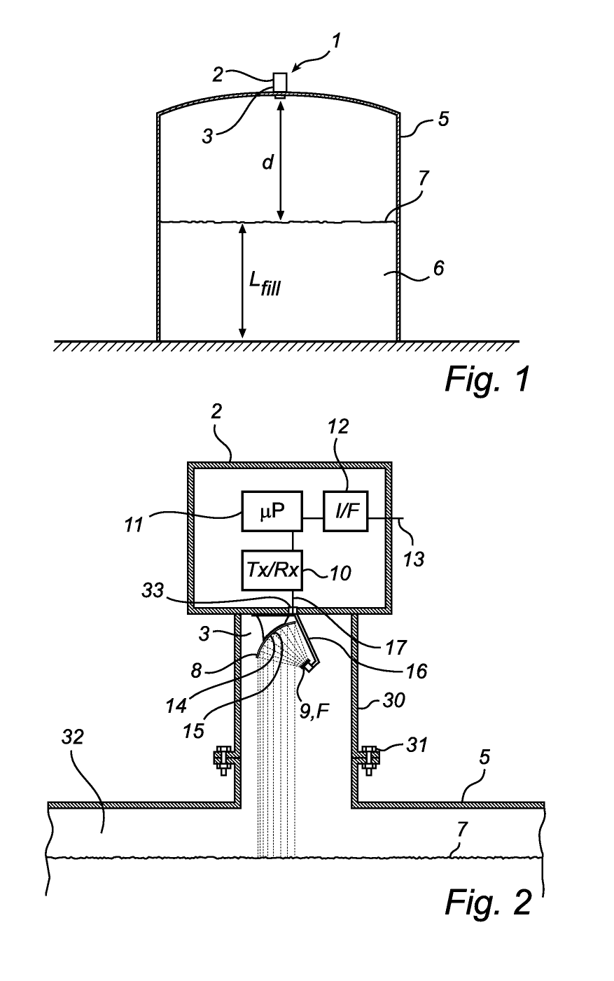

FIG. 1 schematically illustrates a radar level gauge system 1, according to an exemplary embodiment of the present invention, comprising a measurement electronics unit 2 and an antenna arrangement 3. The radar level gauge system 1 is mounted on a flange 30 of a tank 5, by bolts 31 or any other means considered appropriate for the current conditions. The RLG (Radar Level Gauge), and thus the antenna arrangement 3, is thereby secured in a measuring position fixed relative the bottom of the tank 5.

The gauge 1 is arranged to perform measurements of a process variable in a tank 5, such as the filling level L_{FILL} of an interface 7 between two (or more) materials 6, 32 in the tank 5. Typically, the first material 6 is a liquid content stored in the tank, e.g. oil, refined products, chemicals and liquid gas, but it may also be a solid material in powder form or granulate, such as grain or pellets. The second material 32 is typically air or some other atmosphere present in the tank above the first material 6.

Note that different materials have different impedance, and that the electromagnetic waves will only propagate through some materials in the tank. Typically, therefore, only the level of a first interface is measured, or a second interface if the top material is sufficiently transparent.

By analyzing transmitted signals being directed towards the surface 7 of the product 6, and reflected signals traveling back from the surface 7, the measurement electronics unit 2 can determine the distance d between a reference position and the surface 7 of the product 6. This distance d may be used to calculate the filling level L_{FILL}, or some other process variable of interest.

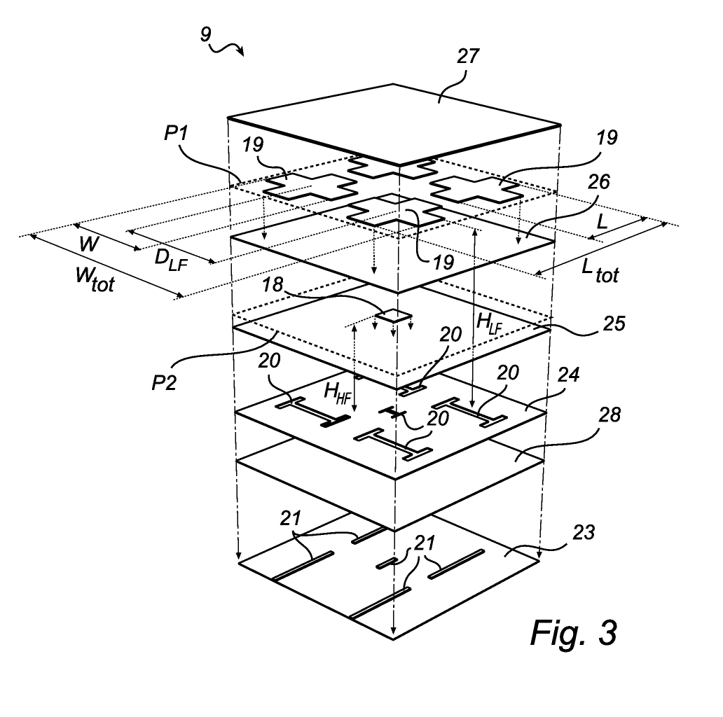

As is schematically illustrated in FIG. 2, the electronics unit 2 comprises a transceiver 10 for transmitting and receiving electromagnetic signals and a processing unit 11, which is connected to the transceiver 10 for control of the transceiver and processing of signals received by the transceiver for determination of the filling level L_{FILL} of the product 6 in the tank 5. The transceiver 10 may be one functional unit capable of transmitting and receiving electromagnetic signals, or may be a system comprising separate transmitter and receiver units. The processing unit 11 is connectable to external communication lines 13 for analog and/or digital communication via an interface 12. Moreover, although not shown in FIG. 2, the radar level gauge system 1 is typically connectable to an external power source, or may be powered through the external communication lines 13. Alternatively, the radar level gauge system 1 may be configured to communicate wirelessly.

The distribution of the microwave signal between measurement electronics unit 2 and the antenna arrangement 3 may, as shown in FIG. 2, be accomplished by means of a transmission line 17. This transmission line 17 is preferably provided by means of a coaxial wire, but may likewise be provided by any appropriate wave guide. Coaxial lines, micro strip lines, strip lines or other TEM-lines inherently have wideband functionality and can be used. Furthermore, in the case of a plurality of frequency bands, separate transmission lines 17, e.g. coaxial wires, may be utilized for the different bands.

The RLG is preferably provided with a feed through structure 33, allowing the transmission line 17 to pass through the tank wall. This feed through structure 33 may provide a gas tight sealing capable of withstanding temperature, pressure, and any chemicals contained in the tank.

According to the embodiment illustrated in FIG. 2, the antenna arrangement 3 comprises a feeder for emitting electromagnetic radiation, and a reflector 8, which is illuminated by radiation from the feeder. The feeder here includes a multi band patch antenna array 9. The reflector 8, which surface may be entirely passive, can be solid, mesh or wire in construction and the reflector 8 may be either fully circular or somewhat rectangular depending on the radiation pattern of the multi band patch antenna array 9. The reflector 8 may furthermore be configured as a reflectarray comprising thin membranes, such as described in “A High Efficiency Offset-Fed X/Ka-Dual-Band Reflectarray Using Thin Membranes”, by Chulmin Han et al., IEEE TRANSACTIONS ON ANTENNAS AND PROPAGATION, VOL. 53, NO. 9, SEPTEMBER 2005. In the exemplary embodiment shown, the diameter of the reflector 8 is approximately 8″, but the invention likewise concerns reflectors 8 of other sizes.

The embodiment illustrated in FIG. 2 relates to a so called “offset” antenna arrangement. This means that the reflector 8 is only a selected portion of an imagined “full size” parabolic antenna dish, i.e. an antenna having the form of an elliptic or circular paraboloid, having a distinct focal point F, wherein the selected portion does not include the center (i.e. the extreme point or origo) of the paraboloid. The array 9 is located in the focal point F of the imagined paraboloid, and arranged to illuminate the reflector 8. As all groups of radiator elements emit radiation having a substantially equal footprint at a certain distance from the array 9, the selected portion may be optimized to the size of this radiation footprint.

In an offset antenna arrangement as shown in FIG. 2, as the reflector 8 does not include the center point of the imagined paraboloid, the array 9 will be located out of a beam path of radiation reflected by the reflector 8, so that interference between the array 9 and the main beam is avoided. Furthermore, as the reflector 8 does not include the center point of the imagined parabola, the array 9 must be slightly tilted to direct emitted radiation to illuminate the reflector 8. Thereby, any fluid condensated or splashed on the antenna array 9 will be drained from the array 9. Note, however, that the present invention likewise covers the reflector 8 being adapted such that the focal point interferes with the main beam, should that be preferred.

As the array 9 is provided in this focal point F, the reflector 8 illuminated by a radiation from the array 9 will produce a parallel microwave beam propagating, preferably perpendicular, towards the product 6 contained in the tank 5. That is, the radiation from the array 9 induces a current flow in the conductive surface of the reflector 8 which, in turn, re-radiates in the desired direction. Additionally, the reflector 8 receives the reflected signals traveling back from the surface 7, and concentrates them to the focal point, which for the shown embodiment as described coincides with the position of the array 9. The reflected signals are then provided from the array 9 to the transceiver 10 through the transmission line 17, which preferably is provided through, or in close proximity to, a support 16 additionally mounting the array 9 to the reflector 8 and/or electronics unit 2.

In order to compensate for various factors complicating the measuring process of the product level, such as disturbing structures within the tank 5, or for instance foam layers on the surface 7, utilization of multiple, widely separated frequency bands is known in the art. Support of multiple frequency bands is described in for instance U.S. Pat. No. 7,053,630, which is hereby incorporated by reference.

In the illustrated embodiment of FIG. 2, the radar level gauge is adapted for use of two widely separated frequency bands. The separation of the frequency bands is preferably sufficient enough to get optimal function over a range of operation conditions in the tank 5. A low frequency band, for instance, will typically be less affected by foam on the surface 7 and dirt on the antenna arrangement 3, while the echo in a high frequency band might be less susceptible to disturbance echoes, e.g. caused by tank structures. Also, the first frequency band may consist of frequencies having a relatively high penetration through water, and the second frequency band consists of frequencies having a relatively low penetration through water.

A ratio between the center frequencies of the two frequency bands is typically at least 1.5. and preferably at least two. According to one implementation, the first frequency band consists of frequencies below 12 GHz, and the second frequency band consists of frequencies above 22 GHz. The bandwidth of the first and second frequency bands can be within the range 0.5-3 GHz. As an example, the low frequency band can be in the approximate range 4-7 GHz and the high frequency band in the approximate range 24-27 GHz.

Although preferred, the present invention is not restricted to these frequency bands, and may likewise support completely different, widely separated frequency band, ranging around for instance 10, 60 or 77 GHz. Furthermore, although the embodiment of FIG. 2 is adapted to support two frequency bands, the scope of the present invention likewise covers support of any number of frequency bands, e.g. three.

During operation, the electronics circuitry 2 controls switching between the different frequencies on which the antenna arrangement 3 may operate. The electronics unit 2 generates an electromagnetic signal and transmits it via the transmission line 17 to the antenna array 9. The antenna array 9 emits microwaves towards the reflector 9, and the microwaves are directed into the tank 5. Microwaves reflected by the surface 6 are collected by the reflector 8, and received by the antenna array 9. The received signal is processed in a manner known per se, to form a low frequency signal, which is digitalized and analyzed in the processing unit 11.

The received signal is analyzed on the frequencies of which the level gauge system 1 is transmitting. From the analysis it is then decided in the processing unit 11 on which frequencies the level gauge system 1 will be operated. Furthermore, evaluation is also performed for calculation of the product surface level L_{FILL} in a conventional way. The different echo spectra received from the two different frequency bands are analyzed for determining the level L_{FILL} of the surface 6 in the tank 5 and for being the basis of the analysis of which calculated value being the most accurate. Upon this analysis, the processing unit 11 will adopt the level gauging system 1 to use only one of the frequency bands for determining the accurate value, or to use the values from the two different frequency bands by use of any averaging calculation method.

The exemplary embodiment of FIG. 2 supports multiple, widely separated frequency bands with the use of a single multi band patch antenna array 9. To acquire optimized use of the reflector 8 illuminated by the array 9 when excited, the multi band patch antenna array 9 is designed such that a first radiation footprint 14 in the low frequency band, and a second radiation footprint 15 in the high frequency band, are essentially equal at a certain distance from the array 9. Furthermore, the reflector 8 is arranged at this certain distance and adapted to have a size essentially corresponding to the radiation footprints. Thereby, the full reflector 8 area is utilized in an efficient way, and little or no radiation is lost.

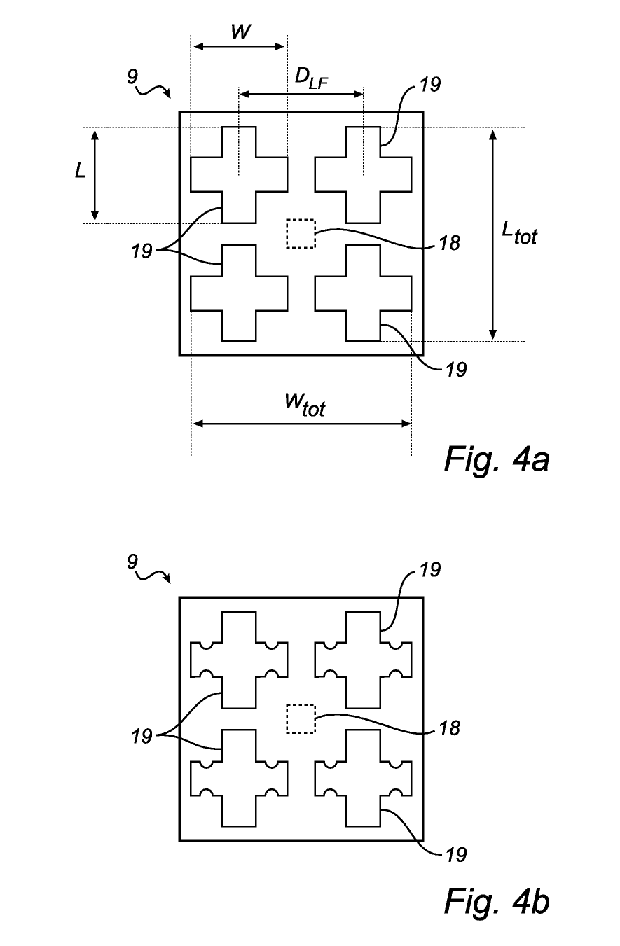

FIG. 3 illustrates, in an exploded view, an exemplifying design of the array 9 comprised in the embodiment shown in FIG. 2, providing substantially equal first and second radiation footprints 14, 15. Essential to the present invention is that the multi band patch antenna array 9 comprises radiator elements, why for the exemplary embodiment supporting two widely separate frequency bands, there is provided low frequency radiator elements, LF-elements, 19 forming a first group, and high frequency radiator elements, HF-elements, 18 forming a second group. The first group thus illuminates the first radiation footprint 14, and the second group the second radiation footprint 15.

In order for the array 9 to function, the array 9 furthermore needs to be arranged with a plurality of dielectric and conductive layers. Single layer or multiple layer printed circuit boards (PCB), may be used to form the various layers. The dielectric material of the different layers, or sections thereof, may, where feasible, be of for instance air or ROHACELL®. As can be seen from a bottom of the array 9 to a top facing the reflector 8, the array 9 here comprises a layer 23 of a dielectric material, in or on top of which micro strip probes 21 are provided. The micro strip probes 21 are arranged to coincide with the positions of the radiator elements 18, 19 provided further up, such that a micro strip probe 21 is positioned underneath each radiator element 18, 19, preferably along a desired polarization direction. The micro strip probes 21 may be of any feasible dimensions and materials. On top of the bottom dielectric layer 23 and micro strip probes 21, yet another layer 28 of dielectric material is provided. Next, a layer 24 of conductive material, acting as a ground plane, is applied, in which layer 24 slots 20 are provided. The slots 20 are arranged to coincide with the positions of the radiator elements 18,19, such that a slot 20 is positioned underneath each radiator element 18,19. A slot 20 may be of any feasible dimension, but is preferably H-shaped, and arranged with the “legs” of the “H” in a direction parallel with the polarization direction of the corresponding radiator element 18, 19. Next is yet another layer 25 of dielectric material applied, on top of which the radiator elements of the second group, that is the HF-elements 18, are arranged, representing a plane P2. On top of the radiator elements 18 of the second group, yet another layer 26 of dielectric material is applied, onto which, the radiator elements of the first group, that is the LF-elements 19, are arranged, representing a plane P1. Note that the dielectric layers 25 and 26 may be formed as one layer, in which the HF radiator elements 18 are embedded. On the top is finally a dielectric cover 27 arranged, which is provided essentially for protection of the multi band patch antenna array 9. Although all layers essential to the array 9 of the exemplary embodiment of FIG. 3 are shown and have been described, additional layers, ground planes or parts may in addition be comprised in the array 9, should that be considerer necessary or even preferred.

With the array 9 of FIG. 3, an radiator element 18, 19 is excited in that the corresponding micro strip probe 21, with support of the corresponding crossing slot 20, induces a current, thereby activating the resonance of the element 18, 19. Although activation in this manner is preferred, the present invention is not restricted thereto, and the radiator elements 18, 19 may be excited by other known means.

The characteristics of an element 18, 19, such as the bandwidth, is affected by the height on which that element is placed above the ground plane 24, i.e. the conductive layer 24 in which the slots 20 are provided. In order to optimize the respective bandwidths for the radiator elements of the first and second groups separately, the planes of the first and the second groups P1, P2 are thus, due to the differing characteristics of the HF- and LF-elements 18, 19, preferably arranged, as illustrated, at different heights. Consideration thus needs to be taken to the respective desired heights in designing the thickness of the layers of the array 9, why these may range from a few μm to several mm. With regards to the radiator elements 18, 19, an element, preferably of metal, may have a thickness ranging from approximately 30 to 55 μm. If feasible, however, other materials and dimensions are likewise covered by the present invention. In the shown embodiment of FIG. 3, the radiator elements 19 of the second group, and subsequently the plane P2, are arranged at a height H_{HF} above the ground plane 24, here approximately 1.0 mm, meanwhile the radiator elements 19 of the first group, and subsequently plane P1, are arranged at a height H_{LF} above the ground plane 24, here approximately 2.4 mm. In arranging the planes P1, P2 at preferred different heights above the ground plane 24, the plane P1 of the first group is thus, as shown in the embodiment of FIG. 3, positioned relatively closer to the reflector 8 than the plane P2 of the second group is.

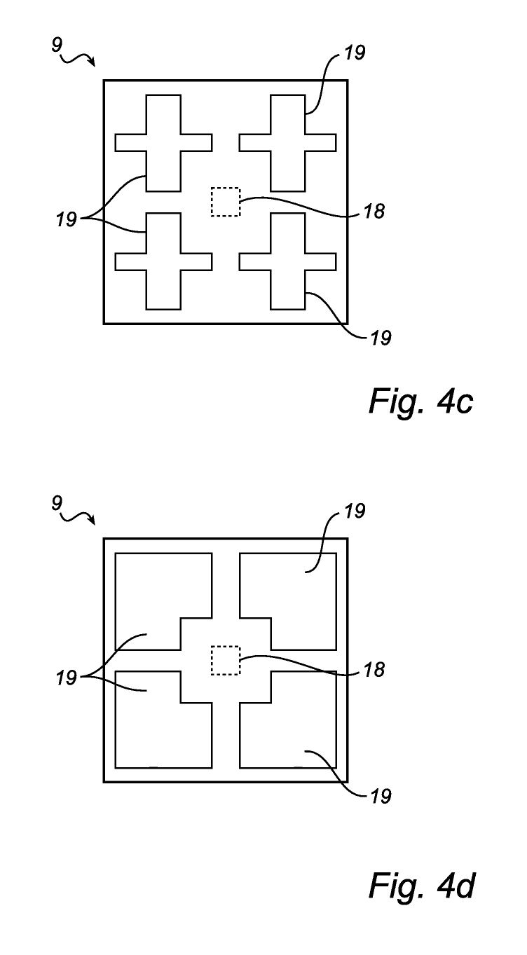

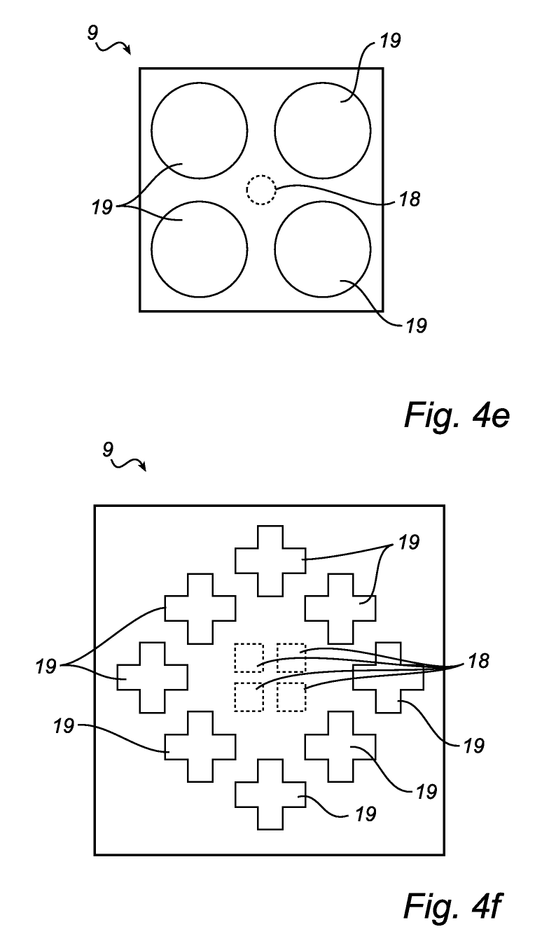

In order to facilitate the description of the arrangement of the radiator elements 18, 19 shown FIG. 3, FIG. 4A illustrates, from a top view, the planes P1, P2 comprising the respective radiator elements 18, 19. As the plane P2 comprising the elements of the second group is placed underneath the plane P1 comprising the elements of the first group, the outlines of the elements 18 of the second group have dashed lines.

The shapes of the different LF-elements 19 are preferably, as shown, identical, whereby the frequencies, and likewise the bandwidths of the radiator elements 19, may coincide, representing the low frequency band. The same applies for the radiator elements 18 of the second group, subsequently representing the high frequency band.

The four radiator elements 19 of the first group are preferably, although not necessarily, as shown in FIG. 4A placed essentially symmetrically surrounding the second group of HF-elements 18. As shown, a distance D_{LF} between the center points of two adjacent LF-elements 19 is preferably shorter than 1 wavelength of the highest frequency within the low frequency band, in order to avoid grating lobes. The term “adjacent LF-elements” is, in the context of this application, to be understood in a broad sense, meaning LF-elements 19 arranged right next to one another, or slightly displaced in relation to one another, in any direction. In the shown embodiment, the distance D_{LF} between two adjacent elements 19 is identical in a width and a length direction. However, in order to improve the circular symmetry in the lobe from the array 9 in the lower frequency band, the distance D_{LF} in the width direction may differ from the distance D_{LF} in the length direction. The same applies for the relation between HF-elements 18, should there be more than one. In order to contribute to an optimized arrangement, the second group comprises a single square-shaped HF-element 18. Imagining the LF-elements 19 of the exemplifying embodiment of FIG. 4A originally having square shapes, then the corners of the LF-elements 19 facing the HF-element 18 have been removed for improved interaction with the HF-element 18. Furthermore, in order to preserve symmetry, the remaining three corners of the LF-elements 19 have likewise been removed, thereby forming cross-shaped LF-elements 19. In order to even further preserve symmetry, the total width W_{TOT} of the arrangement of elements 18, 19 is preferably, and as shown, substantially equal to a total length L_{TOT}.

An element 18, 19 has a length L in the polarization direction of that element, and L is by definition half a wavelength of the center frequency within the element's frequency band. An element furthermore has a width W perpendicular to the elements polarization direction L. The width W affects the elements bandwidth, i.e. the frequency range within which the element operates, in that, to some extent, the wider the width W, the wider the frequency band. The bandwidth is however additionally affected by other factors, such as an element's 18, 19 height above a ground plane 24 comprising slots 20 as described in the foregoing and the details of the element's feed structure, e.g. width of a slot 20 or a length of a probe 21 in relation to a corresponding slot 20, which consequently needs to be taken into consideration in designing the array 9. In the illustrated embodiment of FIG. 4A, the width W of an LF-element 19 is identical to the length L, here being 12.5 mm, such that symmetry is obtained. For the square-shaped HF-element 18, the length, and consequently the width, is here approximately 2.9 mm.

As may be realized by the skilled person, it is the combination of dimensions, shapes, positioning and number of elements 18, 19 which contributes to, and thus enables for, the substantially equal radiation footprints 14, 15. The present invention is however not restricted to the arrangement of the radiator elements 18, 19 of the illustrated embodiment of FIG. 4A; substantially equal radiation footprints 14, 15 may likewise be provided utilizing a plurality of HF-elements 18, an alternative number of LF-elements 19, various element shapes, and various positioning of the elements 18, 19, as will be shown in FIGS. 4B to 4F hereinafter.

FIG. 4B schematically illustrates an alternative arrangement of the radiator elements 18, 19 according to the present invention. The design is similar to that in the embodiment of FIG. 4A, with the exception of the design of the LF-elements 19. Here, each radiator element 19 of the first group has been provided with a notch 41 in an area close to the HF-element 18, along the LF-element's 19 width W. In order to preserve symmetry, three additional notches 41 have been provided, for each LF-element 19, along the width W. Arranging notches 41 as shown, or in similar manners, may contribute to avoidance of the LF-elements 19 being excited by the neighboring HF-elements 18, and subsequently avoidance of currents being induced incorrectly in the LF-elements 19.

FIG. 4C illustrates another alternative arrangement of the radiator elements 18, 19 according to the present invention. The design is similar to that in the embodiment of FIG. 4A, with the exception of the design of the LF-elements 19. Here, the sizes of the corners of each radiator element 19 of the first group, which have been removed such that the LF-element 19 forms a cross, differs from those shown in FIG. 4A. Instead of the removed corners being square-shaped, they here have rectangular shapes.

FIG. 4D illustrates yet another alternative arrangement of the radiator elements 18, 19 according to the present invention. The design is similar to that in the embodiment of FIG. 4A, with the exception of the design of the LF-elements 19. Here, only the corner of each LF-element 19 facing the HF-element 18, has been removed.

FIG. 4E illustrates still another alternative arrangement of the radiator elements 18, 19 according to the present invention. The design resembles that in the embodiment of FIG. 4A, but here, the corners that have been removed from the LF-elements 19 have left the LF-elements 19 having the shapes of circles. Additionally, the HF-element 18 has a shape of a circle. For these elements 18, 19 to be excited, and subsequently for the low as well as high frequency bands to be generated in a optimized manner, the feeding structure may need to be adapted accordingly.

FIG. 4F illustrates an alternative arrangement of a multi band patch antenna array 9, having a plurality of HF-elements 18, according to the present invention. The design resembles that in the embodiment of FIG. 4A, but here the second group comprises four radiator elements 18, instead of one. Additionally, four additional LF-elements 19 has been added to symmetrically surround the radiator elements 18 of the second group.

The present inventive concept has been described above by way of example, and the person skilled in the art realizes that the present invention by no means is limited to the preferred embodiments described above.

It may also be noted that, for the sake of clarity, the dimensions of certain components illustrated in the drawings may differ from the corresponding dimensions in real-life implementations of the invention, for instance dimensions of parts comprised in the gauge system, specifically devices comprised in the antenna arrangement, dimensions of elements, and thickness of layers comprised in the array, etc.

It should furthermore be obvious that the devices, elements etc. illustrated in the drawings, are not drawn according to scale.

1. A radar level gauge system for determining a process variable of a product contained in a tank, said system comprising:
transceiver circuitry for generating, transmitting and receiving microwave signals on at least a first and a second frequency band, a ratio between center frequencies of said first and second frequency bands being at least 1.5;
an antenna arrangement connected to said transceiver and adapted to emit microwaves towards a surface of the product and to receive microwaves reflected from said surface, and
a measurement electronics unit connected to said transceiver, for determining said process variable based on a relationship between emitted and received microwaves;
said antenna arrangement including:
a reflector;
a multi band patch antenna array arranged at a distance from said reflector and adapted to emit electromagnetic waves to be reflected by said reflector towards said surface, which array has
a first group of radiator elements adapted to emit electromagnetic radiation in said first frequency band, said radiation having a first radiation footprint defined as a projection of radiation in said first frequency band that, at said distance, has sufficient power per area unit to be received by said radiator elements after reflection by said reflector and said surface, and
a second group of radiator elements adapted to emit electromagnetic radiation in said second frequency band, said radiation having a second radiation footprint defined as a projection of radiation in said second frequency band that, at said distance, has sufficient power per area unit to be received by said radiator elements after reflection by said reflector and said surface,
wherein said second radiation footprint is substantially equal to said first radiation footprint, and
wherein said reflector has a size corresponding to said first and second radiation footprints.

2. The antenna arrangement according to claim 1, wherein the radiator elements of said first group are located in a first plane, and the radiator elements of said second group are located in a second plane, said planes being essentially perpendicular to a radiation direction of said array, wherein said first plane is located between said reflector and said second plane.

3. The antenna arrangement according to claim 1, wherein the multi band patch antenna array comprises:
a conductive layer,
a first dielectric layer arranged between the conductive layer and said second group of radiator elements,
a second dielectric layer arranged between said first and second group of radiator elements.

4. The antenna arrangement according to claim 1, wherein radiator elements of said second group each has a rectangular shape.

5. The antenna arrangement according to claim 1, wherein radiator elements of said first group are arranged symmetrically relatively to said second group.

6. The antenna arrangement according to claim 1, wherein said second group consists of only one radiator element.

7. The antenna arrangement according to claim 1, wherein said first group comprises four elements, arranged around said second group.

8. The antenna arrangement according to claim 1, wherein each radiator elements of said first group has a rectangular shape.

9. The antenna arrangement according to claim 1, wherein each radiator element of said first group has a shape of a cross.

10. The antenna arrangement according to claim 1, wherein said first frequency band consist of frequencies having a relatively high penetration through water, and said second frequency band consists of frequencies having a relatively low penetration through water.

11. The antenna arrangement according to claim 1, wherein the first frequency band consists of frequencies below 12 GHz, and the second frequency band consists of frequencies above 22 GHz.

12. The antenna arrangement according to claim 1, wherein the center frequency of the first frequency band is around 6 GHz, and the center frequency of the second frequency band is around 25 GHz.

13. The antenna arrangement according to claim 1, wherein a bandwidth of the first and second frequency bands are within the range 0.5-3 GHz.

14. The antenna arrangement according to claim 1, wherein said array is positioned to essentially coincide with a focal point of said reflector.

15. The antenna arrangement according to claim 1, wherein said array comprises:
a conductive layer separated from said radiator elements by at least one dielectric layer, said conductive layer provided with slots aligned with said radiator elements, and
a plurality of probes, separated from said conductive layer by an additional dielectric layer,
said probes being aligned with said slots and adapted to excite said radiator elements through the corresponding slots.

16. The radar level gauge system according to claim 1, wherein said measurement electronics unit is adapted to, in dependence of a performed analysis of a received microwave signal spectrum, determine on which frequency band(s) the level gauging system shall operate.

101-115. (canceled)
